(19) United States
(12) Patent Application Publication
(10) Pub. No.: US 2026/0196170 A1
(43) Pub. Date: Jul. 9, 2026

(54) PIXEL CIRCUIT, DRIVING METHOD AND DISPLAY APPARATUS

(71) Applicant: BOE Technology Group Co., Ltd., Beijing (CN)

(72) Inventors: Lujiang HUANGFU, Beijing (CN); Li WANG, Beijing (CN); Tuo SUN, Beijing (CN); Libin LIU, Beijing (CN); Jianchao ZHU, Beijing (CN); Xuliang ZHAO, Beijing (CN)

(21) Appl. No.: 18/730,252

(22) PCT Filed: Jul. 31, 2023
(86) PCT No.: PCT/CN2023/110285

§ 371 Date: Jul. 18, 2024

(51) Int. Cl. G09G 3/3233; G09G 3/32

(52) U.S. Cl. CPC G09G 3/3233; G09G 3/32; G09G 2300/0819; G09G 2300/0852; G09G 2310/08; G09G 2320/0247; G09G 2320/0257; G09G 2330/021

(57) ABSTRACT

The present disclosure provides a pixel circuit, a driving method and a display apparatus, including: a light emitting device; a driving transistor, coupled to the light emitting device, and configured to generate a driving current for driving the light emitting device to emit light according to a data voltage; a bias circuit, coupled to a gate of the driving transistor, and configured to provide a signal of a bias voltage signal terminal to the gate of the driving transistor in response to a signal of a first control signal terminal; a data writing circuit, coupled to a first node; a coupling control circuit, coupled to the gate of the driving transistor and the first node; and a light emitting control circuit, coupled to the light emitting device and the driving transistor.

### CROSS REFERENCE TO RELATED APPLICATIONS

The present disclosure is a US National Stage of International Application No. PCT/CN2023/110285, filed on Jul. 31, 2023, the entire contents of which are incorporated herein by reference.

### TECHNICAL FIELD

The present disclosure relates to the field of display technology, and in particular to a pixel circuit, a driving method and a display apparatus.

### BACKGROUND

Light emitting devices, such as organic light emitting diode (OLED), quantum dot light emitting diode (QLED), micro light emitting diode (Micro LED), and mini light emitting diode (Mini LED), have advantages of self-illumination, low power consumption and the like, and are one of hot spots in the field of display apparatus application research nowadays. Generally, a pixel circuit is used in a display apparatus to drive a light emitting device to emit light.

### SUMMARY

A pixel circuit provided by an embodiment of the present disclosure includes:
a light emitting device;
a driving transistor, coupled to the light emitting device, and configured to generate a driving current for driving the light emitting device to emit light according to a data voltage;
a bias circuit, coupled to a gate of the driving transistor, and configured to provide a signal of a bias voltage signal terminal to the gate of the driving transistor in response to a signal of a first control signal terminal;
a data writing circuit, coupled to a first node, and configured to provide the data voltage of a data signal terminal to the first node in response to a signal of a scan signal terminal;
a coupling control circuit, coupled to the gate of the driving transistor and the first node, and configured to couple the data voltage of the first node to the gate of the driving transistor; and
a light emitting control circuit, coupled to the light emitting device and the driving transistor, configured to make conduction between a second electrode of the driving transistor and the light emitting device, and drive the light emitting device to emit light, in response to a signal of a light emitting control signal terminal.

In some possible implementations, the bias circuit includes: a first transistor;
a gate of the first transistor is coupled to the first control signal terminal, a first electrode of the first transistor is coupled to the gate of the driving transistor, and a second electrode of the first transistor is coupled to the bias voltage signal terminal.

A pixel circuit provided by an embodiment of the present disclosure includes:
a light-emitting device;
a driving transistor, coupled to the light emitting device, and configured to generate a driving current for driving the light emitting device to emit light according to a data voltage;
a data writing circuit, coupled to a first node, and configured to provide the data voltage of the data signal terminal to the first node in response to a signal of a scan signal terminal;
a conduction control circuit, coupled to the gate of the driving transistor and a second node, and configured to make conduction between the gate of the driving transistor and the second node in response to a signal of a second control signal terminal;
a coupling control circuit, coupled to the first node and the second node, and configured to couple the data voltage of the first node to the second node; and
a light emitting control circuit, coupled to the light emitting device and the driving transistor, configured to make conduction between a second electrode of the driving transistor and the light emitting device, and drive the light emitting device to emit light, in response to a signal of a light emitting control signal terminal.

In some possible implementations, the conduction control circuit includes: a first transistor;
a gate of the first transistor is coupled to the second control signal terminal, a first electrode of the first transistor is coupled to the second node, and a second electrode of the first transistor is coupled to the gate of the driving transistor.

In some possible implementations, the data writing circuit includes: a second transistor; a gate of the second transistor is coupled to the scan signal terminal, a first electrode of the second transistor is coupled to the data signal terminal, and a second electrode of the second transistor is coupled to the first node.

In some possible implementations, the coupling control circuit includes: a first capacitor;
a first electrode of the first capacitor is coupled to the gate of the driving transistor or the second node, and a second electrode of the first capacitor is coupled to the first node.

In some possible implementations, the coupling control circuit includes: a second capacitor and a third capacitor;
a first electrode of the second capacitor is coupled to the gate of the driving transistor or a second node, and a second electrode of the second capacitor is coupled to a first electrode of the third capacitor; and
a second electrode of the third capacitor is coupled to the first node.

In some possible implementations, the light emitting control circuit includes: a third transistor;
a gate of the third transistor is coupled to the light emitting control signal terminal, a first electrode of the third transistor is coupled to the second electrode of the driving transistor, and a second electrode of the third transistor is coupled to the light emitting device.

In some possible implementations, further included is a first control circuit, coupled to the gate of the driving transistor or a second node, and coupled to the second electrode of the driving transistor, and configured to control the second electrode of the driving transistor to form a conducting path with the gate of the driving transistor or the second node in response to a signal of a third control signal terminal.

In some possible implementations, the first control circuit includes: a fourth transistor;
a gate of the fourth transistor is coupled to the third control signal terminal, a first electrode of the fourth transistor is coupled to a second electrode of the driving transistor, and a second electrode of the fourth transistor is coupled to the gate of the driving transistor or the second node.

In some possible implementations, further included is a second control circuit, coupled to the coupling control circuit, and configured to provide a signal of a first reference voltage signal terminal to the coupling control circuit in response to a signal of a fourth control signal terminal or a fifth control signal terminal.

In some possible implementations, the second control circuit includes: a fifth transistor and a sixth transistor;
a gate of the fifth transistor is coupled to the fourth control signal terminal, a first electrode of the fifth transistor is coupled to the first reference voltage signal terminal, and a second electrode of the fifth transistor is coupled to the coupling control circuit;
a gate of the sixth transistor is coupled to the fifth control signal terminal, a first electrode of the sixth transistor is coupled to the first reference voltage signal terminal, and a second electrode of the sixth transistor is coupled to the coupling control circuit.

In some possible implementations, further included is a third control circuit, coupled to the first node, and configured to provide a signal of a second reference voltage signal terminal to the first node in response to a signal of the sixth control signal terminal.

In some possible implementations, the third control circuit includes: a seventh transistor;
a gate of the seventh transistor is coupled to the signal of the sixth control signal terminal, a first electrode of the seventh transistor is coupled to the second reference voltage signal terminal, and a second electrode of the seventh transistor is coupled to the first node.

In some possible implementations, further included is a reset circuit, coupled to a gate of the driving transistor or a second node, and coupled to the light emitting device, configured to provide a signal of an initialization voltage signal terminal to the gate of the driving transistor or the second node, and the light emitting device, respectively, in response to a signal of a reset signal terminal.

In some possible implementations, the reset circuit includes: an eighth transistor and a ninth transistor;
a gate of the eighth transistor is coupled to the reset signal terminal, a first electrode of the eighth transistor is coupled to the gate of the driving transistor or the second node, and a second electrode of the eighth transistor is coupled to the initialization voltage signal terminal; and
a gate of the ninth transistor is coupled to the reset signal terminal, a first electrode of the ninth transistor is coupled to the light emitting device, and a second electrode of the ninth transistor is coupled to the initialization voltage signal terminal.

A display apparatus provided by an embodiment of the present disclosure includes the above pixel circuit.

A driving method of the above pixel circuit provided by an embodiment of the present disclosure includes:
in a bias stage, providing, by the bias circuit, the signal of the bias voltage signal terminal to the gate of the driving transistor in response to the signal of the first control signal terminal;
in a data writing stage, providing, by the data writing circuit, the data voltage of the data signal terminal to the first node in response to the signal of the scan signal terminal; and
in a light emitting stage, coupling, by the coupling control circuit, the data voltage of the first node to the gate of the driving transistor; and make conduction, by the light emitting control circuit, between the second electrode of the driving transistor and the light emitting device, and driving the light emitting device to emit light, in response to the signal of the light emitting control signal terminal.

The driving method of the above pixel circuit provided by an embodiment of the present disclosure includes:
in a data writing stage, providing, by the data writing circuit, the data voltage of the data signal terminal to the first node in response to the signal of the scan signal terminal;
in a threshold detection stage, making conduction, by the conduction control circuit, between the gate of the driving transistor and the second node in response to the signal of the second control signal terminal; and
in a light emitting stage, coupling, by the coupling control circuit, the data voltage of the first node to the second node; making conduction, by the light emitting control circuit, between the second electrode of the driving transistor and the light emitting device, and driving the light emitting device to emit light, in response to the signal of the light emitting control signal terminal.

### BRIEF DESCRIPTION OF FIGURES

FIG. 1 is a schematic diagram of some structures of a pixel circuit provided by an embodiment of the present disclosure.

FIG. 2 is a schematic diagram of some other structures of a pixel circuit provided by an embodiment of the present disclosure.

FIG. 3 is a flow diagram of some driving methods of a pixel circuit provided by an embodiment of the present disclosure.

FIG. 4 is a timing diagram of some signals provided by an embodiment of the present disclosure.

FIG. 5 is a timing diagram of some other signals provided by an embodiment of the present disclosure.

FIG. 6 is a schematic diagram of some other structures of a pixel circuit provided by an embodiment of the present disclosure.

FIG. 7 is a timing diagram of some further signals provided by an embodiment of the present disclosure.

FIG. 8 is a timing diagram of some further signals provided by an embodiment of the present disclosure.

FIG. 9 is a schematic diagram of some further structures of a pixel circuit provided by an embodiment of the present disclosure.

FIG. 10 is a timing diagram of some further signals provided by an embodiment of the present disclosure.

FIG. 11 is a timing diagram of some further signals provided by an embodiment of the present disclosure.

FIG. 12 is a schematic diagram of some further structures of a pixel circuit provided by an embodiment of the present disclosure.

FIG. 13 is a timing diagram of some further signals provided by an embodiment of the present disclosure.

FIG. 14 is a timing diagram of some further signals provided by an embodiment of the present disclosure.

FIG. 15 is a schematic diagram of some other structures of a pixel circuit provided by an embodiment of the present disclosure.

FIG. 16 is a schematic diagram of some other structures of a pixel circuit provided by an embodiment of the present disclosure.

FIG. 17 is a flow diagram of some other driving methods of a pixel circuit by an embodiment of the present disclosure.

FIG. 18 is a timing diagram of some further signals provided by an embodiment of the present disclosure.

FIG. 19 is a timing diagram of some further signals provided by an embodiment of the present disclosure.

FIG. 20 is a schematic diagram of some further structures of a pixel circuit provided by an embodiment of the present disclosure.

FIG. 21 is a timing diagram of some further signals provided by an embodiment of the present disclosure.

### DETAILED DESCRIPTION

In order to make the purpose, technical solutions and advantages of the embodiments of the present disclosure clearer, the technical solutions of the embodiments of the present disclosure will be clearly and completely described below in conjunction with the drawings of the embodiments of the present disclosure. Apparently, the described embodiments are some of the embodiments of the present disclosure, not all of them. The embodiments and features in the embodiments in the present disclosure may be combined mutually if there is no conflict. Based on the described embodiments of the present disclosure, all other embodiments obtained by those skilled in the art without creative effort fall within the protection scope of the present disclosure.

Unless otherwise defined, the technical terms or scientific terms used in the present disclosure shall have the usual meanings understood by those skilled in the art to which the present disclosure belongs. “First”, “second” and similar words used in the present disclosure do not indicate any order, quantity or importance, but are only used to distinguish different components. “Comprising” or “including” and similar words mean that the elements or items appearing before the word include the elements or items listed after the word and their equivalents, without excluding other elements or items. Words such as “connected” or “coupled” are not limited to physical or mechanical connections, but may include electrical connections, whether direct or indirect.

It should be noted that a size and a shape of each figure in the accompanying drawings do not reflect true scales, and are merely to illustrate contents of the present disclosure. Identical or similar reference numerals denote identical or similar elements or elements having identical or similar functions throughout.

At present, a low temperature poly-crystal silicon thin film transistor (LTPS TFT) is used as a main device for forming a pixel circuit in, for example, most active matrix organic light emitting diode (AMOLED) display panels. Due to the spatial variation and the non-uniformity of a threshold voltage (Vth) of the LTPS TFT, the pixel circuit used generally needs to compensate for the spatial variability of a threshold voltage Vth of a driving transistor (Driving Thin Film Transistor, DTFT). Wherein, in the process of compensating for the spatial variability of the threshold voltage Vth of the driving transistor, a certain impact will also be exerted on the temporal variability of the threshold voltage Vth of the driving transistor. Wherein, the temporal variability of the threshold voltage Vth of the driving transistor relates to various device physical mechanisms. For example, a border state defect level of a gate insulating layer close to an interface of a conducting channel can trap carriers or charges from the conducting channel or release carriers or charges to the conducting channel as a bias voltage Vgs of the driving transistor varies, resulting in a variation in the threshold voltage Vth of the driving transistor. For a conventional periodic operating process of the pixel circuit, the deviation or relaxation (recover) process of the threshold voltage Vth of the driving transistor with the bias voltage Vgs apparently lags behind the variation process of the bias voltage Vgs, which is called hysteresis characteristics of the threshold voltage Vth.

Exemplarily, the hysteresis characteristics of the threshold voltage Vth of the driving transistor will have a certain impact on the display screen, e.g. a screen display of a previous frame may have an impact on a screen display of a next frame, thus producing an (recoverable) image sticking in the display panel. For example, within the same display frame, the operating process of a data refresh stage has a certain impact on the driving current and the display brightness stability in a light emitting stage, so that the display panel will flicker. In addition, the superposition of an association signal (Vref−Vda) of the data voltage Vda and the threshold voltage Vth will also cause the threshold voltage Vth to shift later, and its relaxation process affects the brightness stability of the light emitting stage.

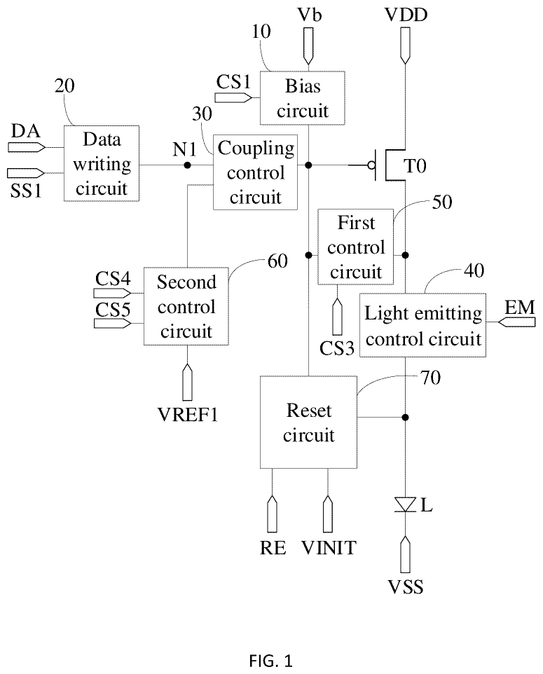

An embodiment of the present disclosure provides a pixel circuit, as shown in FIG. 1, including:
a light emitting device L;
a driving transistor T0, coupled to the light emitting device L, and configured to generate a driving current for driving the light emitting device L to emit light according to a data voltage;
a bias circuit 10, coupled to a gate of the driving transistor T0, and configured to provide a signal of a bias voltage signal terminal VB to the gate of the driving transistor T0 in response to a signal of a first control signal terminal CS1;
a data writing circuit 20, coupled to a first node N1, and configured to provide a data voltage of a data signal terminal DA to the first node N1 in response to a signal of a scan signal terminal SS1;
a coupling control circuit 30, coupled to the gate of the driving transistor T0 and the first node N1, configured to couple the data voltage of the first node N1 to the gate of the driving transistor T0; and
a light emitting control circuit 40, coupled to the light emitting device L and the driving transistor T0, configured to make conduction between a second electrode of the driving transistor T0 and the light emitting device L, and drive the light emitting device L to emit light, in response to a signal of a light emitting control signal terminal EM.

In the embodiment of the present disclosure, by means of the cooperation among the bias circuit, the data writing circuit, the coupling control circuit and the light emitting control circuit, the image sticking problem of the display panel can be relieved, and meanwhile, the brightness stability of the display panel can be increased, the flicker problem of the display panel can be relieved, and the display quality can be improved. It is further favorable for improving a compensation effect of the spatial variability of the threshold voltage Vth, and is also favorable for achieving an energy-saving effect in a low frame rate display state.

Exemplarily, as shown in FIG. 1, a first electrode of the driving transistor T0 is coupled to a first power supply terminal VDD. The driving transistor T0 may be set as a P-type transistor; wherein, the first electrode of the driving transistor T0 may be a source thereof, a second electrode of the driving transistor T0 may be a drain thereof, and when the driving transistor T0 is in a saturated state, an electric current flows from the source of the driving transistor T0 to the drain thereof. Of course, the driving transistor T0 may also be set as an N-type transistor, which is not limited herein.

Exemplarily, as shown in FIG. 1, the second electrode of the light emitting device L is coupled to a second power supply terminal VSS; exemplarily, the light emitting device L may be an electroluminescent light emitting diode. For example, the light emitting device L may include: at least one of an organic light emitting diode (OLED), a quantum dot light emitting diode (QLED), a micro light emitting diode (Micro LED), and a mini light emitting diode (Mini LED). Exemplarily, the light emitting device L may include an anode, a light emitting layer, and a cathode arranged in a laminated manner. Further, the light emitting layer may also include film layers such as a hole injection layer, a hole transport layer, an electron transport layer, and an electron injection layer. Of course, in practical applications, the specific structure of the light emitting device L can be determined according to the needs of the practical applications, which is not limited herein.

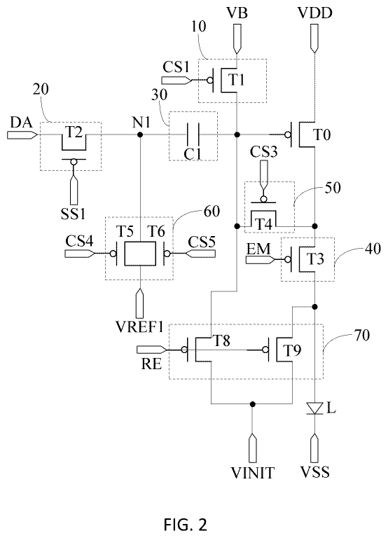

In some embodiments of the present disclosure, as shown in FIG. 2, the bias circuit 10 includes: a first transistor T1; wherein, a gate of the first transistor T1 is coupled to a first control signal terminal CS1, a first electrode of the first transistor T1 is coupled to a gate of the driving transistor T0, and a second electrode of the first transistor T1 is coupled to a bias voltage signal terminal VB.

Exemplarily, the first transistor T1 may be turned on under the control of an active level of a first control signal transmitted on the first control signal terminal CS1, and may be turned off under the control of an inactive level of the first control signal. For example, the first transistor T1 may be set as an N-type transistor, then the active level of the first control signal is a high level, and the inactive level of the first control signal is a low level. Alternatively, the first transistor T1 may be set as a P-type transistor, then the active level of the first control signal is a low level, and the inactive level of the first control signal is a high level.

It should be noted that, the voltage Vb of the bias voltage signal terminal VB is greater than the threshold voltage Vth of the driving transistor T0.

In some embodiments of the present disclosure, as shown in FIG. 2, the data writing circuit 20 includes: a second transistor T2; wherein a gate of the second transistor T2 is coupled to the scan signal terminal SS1, a first electrode of the second transistor T2 is coupled to the data signal terminal DA, and a second electrode of the second transistor T2 is coupled to the first node N1.

Exemplarily, the second transistor T2 may be turned on under the control of an active level of a scan signal transmitted on the scan signal terminal SS1, and may be turned off under the control of an inactive level of the scan signal. For example, the second transistor T2 may be set as an N-type transistor, then the active level of the scan signal is a high level, and the inactive level of the scan signal is a low level. Alternatively, the second transistor T2 may be set as a P-type transistor, then the active level of the scan signal is a low level, and the inactive level of the scan signal is a high level.

In some embodiments of the present disclosure, as shown in FIG. 2, the coupling control circuit 30 includes: a first capacitor C1; wherein a first electrode of the first capacitor C1 is coupled to a gate of the driving transistor T0 or a second node N2, and a second electrode of the first capacitor C1 is coupled to a first node N1.

In some embodiments of the present disclosure, as shown in FIG. 2, the light emitting control circuit 40 includes: a third transistor T3; wherein a gate of the third transistor T3 is coupled to a light emitting control signal terminal EM, a first electrode of the third transistor T3 is coupled to a second electrode of the driving transistor T0, and a second electrode of the third transistor T3 is coupled to the light emitting device L.

Exemplarily, the third transistor T3 may be turned on under the control of an active level of a light emitting control signal transmitted on the light emitting control signal terminal EM, and may be turned off under the control of an inactive level of the light emitting control signal. For example, the third transistor T3 may be set as an N-type transistor, then the active level of the light emitting control signal is a high level, and the inactive level of the light emitting control signal is a low level. Alternatively, the third transistor T3 may be set as a P-type transistor, then the active level of the light emitting control signal is a low level, and the inactive level of the light emitting control signal is a high level.

In some embodiments of the present disclosure, as shown in FIG. 2, further included is a first control circuit 50, coupled to a gate of the driving transistor T0 and a second electrode of the driving transistor T0, and configured to control the second electrode of the driving transistor TO to form a conducting path with the gate of the driving transistor T0 in response to a signal of a third control signal terminal CS3.

In some embodiments of the present disclosure, as shown in FIG. 2, the first control circuit includes: a fourth transistor T4; wherein a gate of the fourth transistor T4 is coupled to the third control signal terminal CS3, a first electrode of the fourth transistor T4 is coupled to a second electrode of the driving transistor T0, and a second electrode of the fourth transistor T4 is coupled to the gate of the driving transistor T0.

Exemplarily, the fourth transistor T4 may be turned on under the control of an active level of a third control signal transmitted on the third control signal terminal CS3, and may be turned off under the control of an inactive level of the third control signal. For example, the fourth transistor T4 may be set as an N-type transistor, then the active level of the third control signal is a high level, and the inactive level of the third control signal is a low level. Alternatively, the fourth transistor T4 may be set as a P-type transistor, then the active level of the third control signal is a low level, and the inactive level of the third control signal is a high level.

In some embodiments of the present disclosure, as shown in FIG. 2, further included is a second control circuit 60, coupled to a coupling control circuit 30, configured to provide a signal of a first reference voltage signal terminal VREF1 to the coupling control circuit 30 in response to a signal of a fourth control signal terminal CS4 or a fifth control signal terminal CS5.

In some embodiments of the present disclosure, as shown in FIG. 2, the second control circuit 60 includes: a fifth transistor T5 and a sixth transistor T6; wherein a gate of the fifth transistor T5 is coupled to the fourth control signal terminal CS4, a first electrode of the fifth transistor T5 is coupled to the first reference voltage signal terminal VREF1, a second electrode of the fifth transistor T5 is coupled to the coupling control circuit 30; a gate of the sixth transistor T6 is coupled to a signal of the fifth control signal terminal CS5, a first electrode of the sixth transistor T6 is coupled to the first reference voltage signal terminal VREF1, and a second electrode of the sixth transistor T6 is coupled to the coupling control circuit 30.

Exemplarily, the fifth transistor T5 may be turned on under the control of an active level of a fourth control signal transmitted on the fourth control signal terminal CS4, and may be turned off under the control of an inactive level of the fourth control signal. For example, the fifth transistor T5 may be set as an N-type transistor, then the active level of the fourth control signal is a high level, and the inactive level of the fourth control signal is a low level. Alternatively, the fifth transistor T5 may be set as a P-type transistor, then the active level of the fourth control signal is a low level, and the inactive level of the fourth control signal is a high level.

Exemplarily, the sixth transistor T6 may be turned on under the control of an active level of a fifth control signal transmitted on the fifth control signal terminal CS5, and may be turned off under the control of an inactive level of the fifth control signal. For example, the sixth transistor T6 may be set as an N-type transistor, then the active level of the fifth control signal is a high level, and the inactive level of the fifth control signal is a low level. Alternatively, the sixth transistor T6 may be set as a P-type transistor, then the active level of the fifth control signal is a low level, and the inactive level of the fifth control signal is a high level.

In some embodiments of the present disclosure, as shown in FIG. 2, further included is a reset circuit 70, coupled to a gate of the driving transistor T0 and coupled to a light emitting device L, configured to provide a signal of an initialization voltage signal terminal VINIT to the gate of the driving transistor T0 and the light emitting device L, respectively, in response to a signal of a reset signal terminal RE.

In some embodiments of the present disclosure, as shown in FIG. 2, the reset circuit includes: an eighth transistor T8 and a ninth transistor T9; wherein a gate of the eighth transistor T8 is coupled to a reset signal terminal RE, a first electrode of the eighth transistor T8 is coupled to a gate of the driving transistor T0, and a second electrode of the eighth transistor T8 is coupled to an initialization voltage signal terminal VINIT; a gate of the ninth transistor T9 is coupled to the reset signal terminal RE, a first electrode of the ninth transistor T9 is coupled to a light emitting device L, and a second electrode of the ninth transistor T9 is coupled to the initialization voltage signal terminal VINIT.

Exemplarily, the eighth transistor T8 may be turned on under the control of an active level of a reset signal transmitted on the reset signal terminal RE, and may be turned off under the control of an inactive level of the reset signal. For example, the eighth transistor T8 may be set as an N-type transistor, then the active level of the reset signal is a high level, and the inactive level of the reset signal is a low level. Alternatively, the eighth transistor T8 may be set as a P-type transistor, then the active level of the reset signal is a low level, and the inactive level of the reset signal is a high level.

Exemplarily, the first electrodes of the above transistors may be sources thereof, and the second electrodes of the above transistors may be drains thereof. Alternatively, the first electrodes are drains thereof, and the second electrodes are sources thereof. There are no limits herein.

A transistor with an active layer made of a low temperature poly-silicon (LTPS) material is generally high in mobility and may be made thinner and smaller as well as lower in power consumption, and during specific implementation, the material of the active layer of the above at least one transistor may set as a low temperature poly-silicon material. Thus, the above transistors may be set as LTPS-type transistors, so that the pixel circuit may be high in mobility and may be made thinner and smaller as well as lower in power consumption.

The leakage current of a transistor with an active layer made of a metal oxide semiconductor material is generally relatively small, thus in order to reduce the leakage current, in some embodiments of the present disclosure, the material of the active layer of the above at least one transistor may include a metal oxide semiconductor material such as indium gallium zinc oxide (IGZO), of course, the material of the active layer of the transistor may also be other metal oxide semiconductor materials, which are not limited herein. Thus, the above transistors may be set as oxide-type transistors (Oxide Thin Film Transistor), so as to reduce the leakage current of the pixel circuit.

Exemplarily, all the transistors may be set as LTPS-type transistors. Alternatively, all the transistors may be set as oxide-type transistors. Alternatively, some of the transistors may be set as oxide-type transistors, while the rest of the transistors as LTPS-type transistors. By combining the two processes for preparing LTPS-type transistors and oxide-type transistors to prepare an LTPO pixel circuit of a low temperature poly-silicon oxide, the leakage current of the gate of the driving transistor T0 may be made relatively small, and the power consumption may be made relatively low. Therefore, when the pixel circuit is applied to a display panel and the display panel performs display at a reduced refresh rate, the display uniformity can be guaranteed.

Exemplarily, the first power supply terminal VDD may be configured to load a constant first power supply voltage Vdd, and the first power supply voltage Vdd is generally a positive value, also, the second power supply terminal VSS may load a constant second power supply voltage Vss, and the second power supply voltage Vss may generally be a ground voltage or a negative value. In practical applications, the specific values of the first power supply voltage Vdd and the second power supply voltage Vss can be designed and determined according to the actual application environment, which are not limited herein.

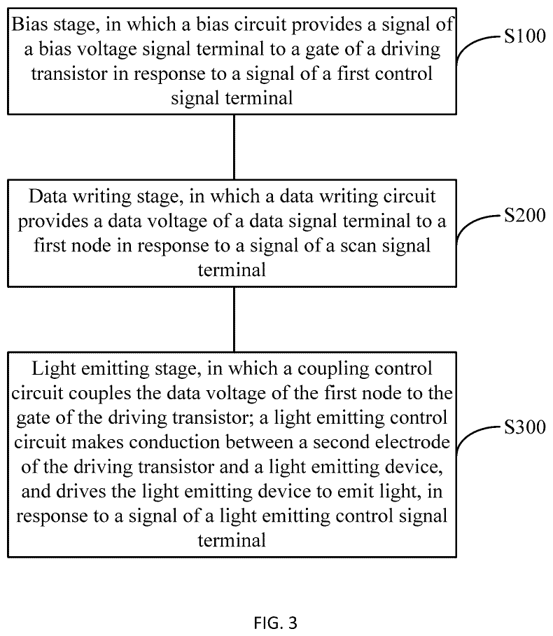

An embodiment of the present disclosure provides a driving method of a pixel circuit, as shown in FIG. 3, including:
S100, a bias stage, in which a bias circuit provides a signal of a bias voltage signal terminal to a gate of a driving transistor in response to a signal of a first control signal terminal;
S200, a data writing stage, in which a data writing circuit provides a data voltage of a data signal terminal to a first node in response to a signal of a scan signal terminal; and
S300, a light emitting stage, in which a coupling control circuit couples the data voltage of the first node to the gate of the driving transistor; a light emitting control circuit enables a conducting path to be formed between a second electrode of the driving transistor and a light emitting device, and drives the light emitting device to emit light, in response to a signal of a light emitting control signal terminal.

It should be noted that, prior to the bias stage, a reset stage may be further included, in which a reset circuit provides a signal of an initialization voltage signal terminal to the gate of the driving transistor and the light emitting device, respectively, in response to a signal of a reset signal terminal. After the bias stage, a threshold detection stage may be further included, in which a first control circuit 50 controls the second electrode of the driving transistor to form a conducting path with the gate of the driving transistor in response to a signal of a third control signal terminal.

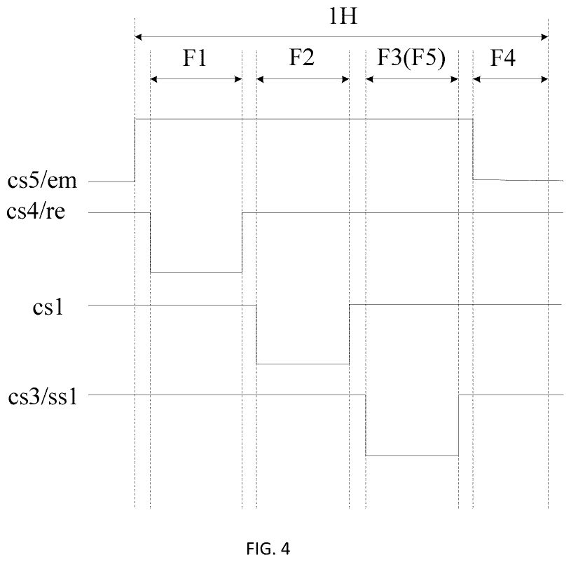

The operating process of the pixel circuit provided by the embodiment of the present disclosure will be described below with reference to the signal timing diagram shown in FIG. 4, by taking the pixel circuit shown in FIG. 2 as an example. The operating process of the pixel circuit in one display frame 1H is taken as an example for description, wherein one display frame 1H may include: a reset stage F1, a bias stage F2, a data writing stage F3, a light emitting stage F4, and a threshold detection stage F5.

Wherein, as shown in FIG. 4, em represents a light emitting signal of a light emitting control signal terminal EM, cs1 represents a first control signal of a first control signal terminal CS1, cs3 represents a third control signal of a third control signal terminal CS3, cs4 represents a fourth control signal of a fourth control signal terminal CS4, cs5 represents a fifth control signal of a fifth control signal terminal CS5, ss1 represents a scan signal of a scan signal terminal SS1, and re represents a reset signal of a reset signal terminal.

In the reset stage F1, the first transistor T1 is turned off under the control of a high level of the first control signal cs1; the second transistor T2 is turned off under the control of a high level of the scan signal ss1; the third transistor T3 is turned off under the control of a high level of the light emitting signal em; the fourth transistor T4 is turned off under the control of a high level of the third control signal cs3; the fifth transistor T5 is turned on under the control of a low level of the fourth control signal cs4; the sixth transistor T6 is turned off under the control of a high level of the fifth control signal cs5; the eighth transistor T8 is turned on under the control of a low level of the reset signal re; and the ninth transistor T9 is turned on under the control of a low level of the reset signal re. The turned-on fifth transistor T5 provides a signal of the first reference voltage signal terminal VREF1 to a first node N1, then the voltage VN1 of the first node N1 is Vref1. The turned-on eighth transistor T8 provides a signal of the initialization voltage signal terminal VINIT to a gate of the driving transistor T0, then the voltage of the gate of the driving transistor T0 is Vinit. Then the bias voltage of the driving transistor T0 is Vgs=Vinit−Vdd, by presetting the value of Vinit, the bias voltage Vgs of the driving transistor T0 may be made smaller than the threshold voltage Vth of the driving transistor T0, and the driving transistor T0 is turned on. The turned-on ninth transistor T9 provides a signal of the initialization voltage signal terminal VINIT to the light emitting device L to reset the light emitting device L. Wherein, Vinit represents a voltage value of the initialization voltage signal terminal VINIT, Vref1 represents a voltage value of the first reference voltage signal terminal VREF1, Vth represents a threshold voltage of the driving transistor T0, Vgs represents a bias voltage of the driving transistor T0, and Vdd represents a voltage value of the first power supply terminal VDD.

In the bias stage F2, the first transistor T1 is turned on under the control of a low level of the first control signal cs1; the second transistor T2 is turned off under the control of a high level of the scan signal ss1; the third transistor T3 is turned off under the control of a high level of the light emitting signal em; the fourth transistor T4 is turned off under the control of a high level of the third control signal cs3; the fifth transistor T5 is turned off under the control of a high level of the fourth control signal cs4; the sixth transistor T6 is turned off under the control of a high level of the fifth control signal cs5; the eighth transistor T8 is turned off under the control of a high level of the reset signal re; and the ninth transistor T9 is turned off under the control of a high level of the reset signal re. The turned-on first transistor T1 provides a signal of the bias voltage signal terminal VB to the gate of the driving transistor T0, then the gate voltage of the driving transistor T0 is Vb, then the bias voltage of the driving transistor T0 is Vgs=Vb−Vdd, by presetting the value of Vb, the bias voltage Vgs of the driving transistor T0 may be made greater than the threshold voltage Vth of the driving transistor T0, and the driving transistor T0 is turned off. Wherein, Vb represents a voltage value of the bias voltage signal terminal VB.

In the data writing stage F3 and the threshold detection stage F5, the first transistor T1 is turned off under the control of a high level of the first control signal cs1; the second transistor T2 is turned on under the control of a low level of the scan signal ss1; the third transistor T3 is turned off under the control of a high level of the light emitting signal em; the fourth transistor T4 is turned on under the control of a low level of the third control signal cs3; the fifth transistor T5 is turned off under the control of a high level of the fourth control signal cs4; the sixth transistor T6 is turned off under the control of a high level of the fifth control signal cs5; the eighth transistor T8 is turned off under the control of a high level of the reset signal re; and the ninth transistor T9 is turned off under the control of a high level of the reset signal re. The turned-on second transistor T2 provides a data voltage Vda of the data signal terminal DA to the first node N1, then the voltage VN1 of the first node N1 is Vda. The turned-on fourth transistor T4 controls the second electrode of the driving transistor T0 to form a conducting path with the gate of the driving transistor T0, the first power supply terminal VDD charges the gate of the driving transistor T0, the voltage of the gate of the driving transistor T0 increases constantly, when the gate voltage of the driving transistor T0 is Vdd+Vth, the bias voltage of the driving transistor T0 is Vgs=Vth, and the driving transistor T0 is turned off. The voltage difference between the two electrodes of the first capacitor C1 is Vdd+Vth−Vda.

In the light emitting stage F4, the first transistor T1 is turned off under the control of a high level of the first control signal cs1; the second transistor T2 is turned off under the control of a high level of the scan signal ss1; the third transistor T3 is turned on under the control of a low level of the light emitting signal em; the fourth transistor T4 is turned on under the control of a low level of the third control signal cs3; the fifth transistor T5 is turned off under the control of a high level of the fourth control signal cs4; the sixth transistor T6 is turned on under the control of a low level of the fifth control signal cs5; the eighth transistor T8 is turned off under the control of a high level of the reset signal re; and the ninth transistor T9 is turned off under the control of a high level of the reset signal re. The first capacitor C1 couples a data voltage of the first node N1 to the gate of the driving transistor T0. The turned-on sixth transistor T6 provides a signal of the first reference voltage signal terminal VREF1 to the first node N1, then the voltage VN1 of the first node N1 is Vref1, since the potential difference between the two ends of the first capacitor C1 remains unchanged, the gate voltage of the driving transistor T0 is Vdd+Vth+Vref1−Vda, the driving transistor T0 is turned on, and the bias voltage of the driving transistor T0 is Vgs=Vth+Vref1−Vda. The turned-on third transistor T3 makes conduction between a second electrode of the driving transistor T0 and the light emitting device L, and drives the light emitting device L to emit light. Then, the driving transistor T0 is operated in a saturation region, and a driving current I generated by the driving transistor T0 may be expressed as:

$$I = \frac{k}{2} * {( Vgs - Vth )}^{2} = \frac{k}{2} * {( Vref 1 - Vda )}^{2} ∘$$

$$Wherein , k = μ {C}_{ox} \frac{W}{L} ,$$

μ represents a mobility of the driving transistor T0, Cox represents capacitance per unit area of a gate insulating layer of the driving transistor T0, and W/L represents a channel width-to-length ratio of the driving transistor T0.

In the present disclosure, during the reset stage, the driving transistor is put in a negative bias state (that is, the bias voltage Vgs of the driving transistor is less than the threshold voltage Vth, and the driving transistor is turned on); during the bias stage, the driving transistor is put in a positive bias state (that is, the bias voltage Vgs of the driving transistor is greater than the threshold voltage Vth, and the driving transistor is turned off); that is, by combining the negative bias state and the positive bias state, the hysteresis characteristics of the driving transistor can be effectively alleviated, and the display quality can be improved.

Exemplarily, prior to the reset stage, a pre-bias stage is further included, in which the bias circuit provides a signal of the bias voltage signal terminal to a gate of the driving transistor in response to a signal of the first control signal terminal.

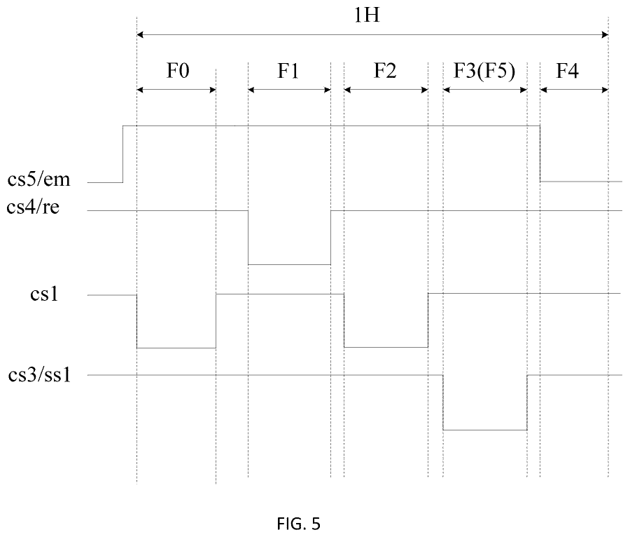

The operating process of the pixel circuit provided by the embodiment of the present disclosure will be described below with reference to the signal timing diagram shown in FIG. 5, by taking the pixel circuit shown in FIG. 2 as an example. The operating process of the pixel circuit in one display frame 1H is taken as an example for description, wherein one display frame 1H may include: a pre-bias stage F0, a reset stage F1, a bias stage F2, a data writing stage F3, a light emitting stage F4, and a threshold detection stage F5.

Wherein, as shown in FIG. 5, em represents a light emitting signal of a light emitting control signal terminal EM, cs1 represents a first control signal of a first control signal terminal CS1, cs3 represents a third control signal of a third control signal terminal CS3, cs4 represents a fourth control signal of a fourth control signal terminal CS4, cs5 represents a fifth control signal of a fifth control signal terminal CS5, ss1 represents a scan signal of a scan signal terminal SS1, and re represents a reset signal of a reset signal terminal.

In the pre-bias stage F0, the first transistor T1 is turned on under the control of a low level of the first control signal cs1; the second transistor T2 is turned off under the control of a high level of the scan signal ss1; the third transistor T3 is turned off under the control of a high level of the light emitting signal em; the fourth transistor T4 is turned off under the control of a high level of the third control signal cs3; the fifth transistor T5 is turned off under the control of a high level of the fourth control signal cs4; the sixth transistor T6 is turned off under the control of a high level of the fifth control signal cs5; the eighth transistor T8 is turned off under the control of a high level of the reset signal re; and the ninth transistor T9 is turned off under the control of a high level of the reset signal re. The turned-on first transistor T1 provides a signal of the bias voltage signal terminal VB to the gate of the driving transistor T0, then the gate voltage of the driving transistor T0 is Vb, then the bias voltage of the driving transistor T0 is Vgs=Vb−Vdd, by presetting the value of Vb, the bias voltage Vgs of the driving transistor T0 may be made greater than the threshold voltage Vth of the driving transistor T0, and the driving transistor T0 is turned off.

Reference may be made to the above description for the operation processes in the reset stage F1, in the bias stage F2, in the data writing stage F3, in the light emitting stage F4, and in the threshold detection stage F5, which will not be repeated here.

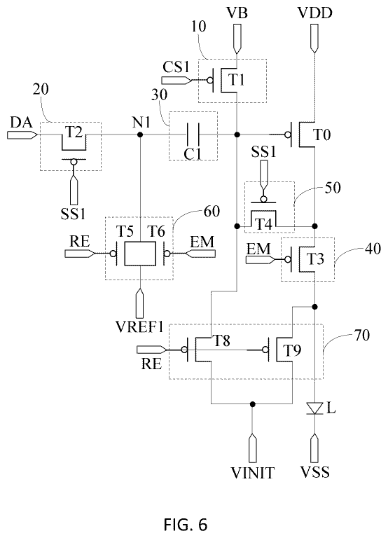

An embodiment of the present disclosure provides a schematic diagram of some other structures of the pixel circuit, which, as shown in FIG. 6, is modified based on the implementation in the above embodiments. The description below is only directed at differences between the present embodiments and the above embodiments, while the similarities between them will not be elaborated.

Exemplarily, a fifth control signal terminal CS5 may be the same signal terminal as a light emitting control signal terminal EM; a fourth control signal terminal CS4 may be the same signal terminal as a reset signal terminal RE; and a third control signal terminal CS3 may be the same signal terminal as a scan signal terminal SS1; whereby the number of signal lines can be reduced, and the space occupied by wiring can be saved.

Exemplarily, a gate of the fourth transistor T4 is coupled to a scan signal terminal SS1. A gate of the fifth transistor is coupled to a reset signal terminal RE. A gate of the sixth transistor T6 is coupled to a light emitting control signal terminal EM.

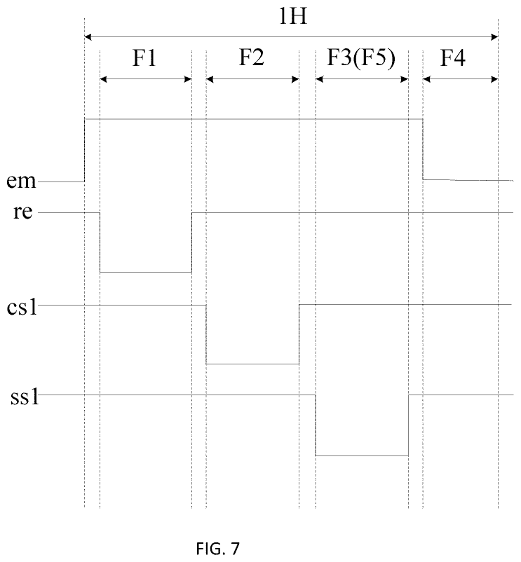

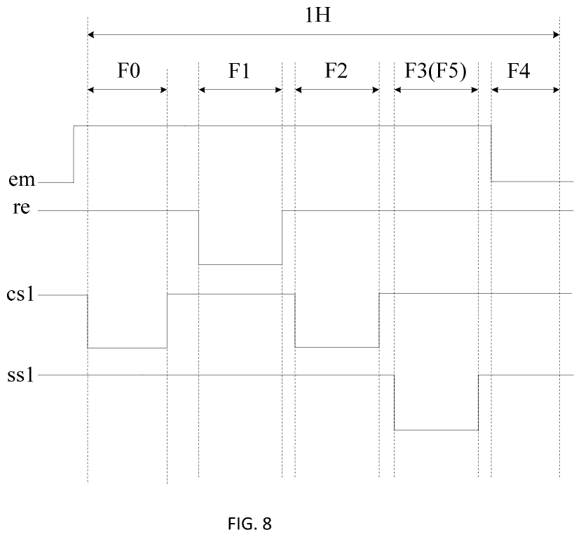

It should be noted that, the signal timing diagram corresponding to the pixel circuit as shown in FIG. 6 may be FIG. 7 or FIG. 8. Moreover, the specific operating process of the pixel circuit as shown in FIG. 6 may be basically the same as the specific operating process of the pixel circuit as shown in FIG. 2, which will not be repeated here.

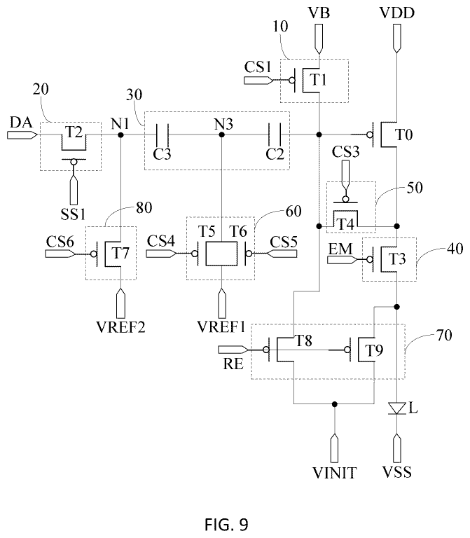

An embodiment of the present disclosure provides a schematic diagram of some further structures of the pixel circuit, which, as shown in FIG. 9, is modified based on the implementation in the above embodiments. The description below is only directed at differences between the present embodiments and the above embodiments, while the similarities between them will not be elaborated.

In some embodiments of the present disclosure, as shown in FIG. 9, the coupling control circuit 30 includes: a second capacitor C2 and a third capacitor C3; wherein a first electrode of the second capacitor C2 is coupled to a gate of the driving transistor T0, a second electrode of the second capacitor C2 is coupled to a first electrode of the third capacitor C3; and a second electrode of the third capacitor C3 is coupled to a first node N1.

In some embodiments of the present disclosure, as shown in FIG. 9, further included is a third control circuit 80, coupled to the first node N1, configured to provide a signal of a second reference voltage signal terminal VREF2 to the first node N1 in response to a signal of a sixth control signal terminal CS6.

In some embodiments of the present disclosure, as shown in FIG. 9, the third control circuit 80 includes: a seventh transistor T7; wherein a gate of the seventh transistor T7 is coupled to the signal of the sixth control signal terminal CS6, a first electrode of the seventh transistor T7 is coupled to the second reference voltage signal terminal VREF2, and a second electrode of the seventh transistor T7 is coupled to the first node N1.

Exemplarily, the seventh transistor T7 may be turned on under the control of an active level of a sixth control signal transmitted on the sixth control signal terminal CS6, and may be turned off under the control of an inactive level of the sixth control signal. For example, the seventh transistor T7 may be set as an N-type transistor, then the active level of the sixth control signal is a high level, and the inactive level of the sixth control signal is a low level. Alternatively, the seventh transistor T7 may be set as a P-type transistor, then the active level of the sixth control signal is a low level, and the inactive level of the sixth control signal is a high level.

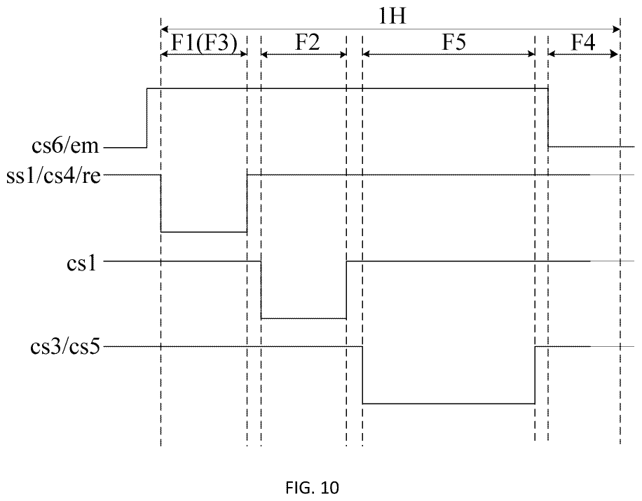

The operating process of the pixel circuit provided by the embodiment of the present disclosure will be described below with reference to the signal timing diagram shown in FIG. 10, by taking the pixel circuit shown in FIG. 9 as an example. The operating process of the pixel circuit in one display frame 1H is taken as an example for description, wherein one display frame 1H may include: a reset stage F1, a bias stage F2, a data writing stage F3, a light emitting stage F4, and a threshold detection stage F5.

Wherein, as shown in FIG. 10, em represents a light emitting signal of a light emitting control signal terminal EM, cs1 represents a first control signal of a first control signal terminal CS1, cs3 represents a third control signal of a third control signal terminal CS3, cs4 represents a fourth control signal of a fourth control signal terminal CS4, cs5 represents a fifth control signal of a fifth control signal terminal CS5, cs6 represents a sixth control signal of a sixth control signal terminal CS6, ss1 represents a scan signal of a scan signal terminal SS1, and re represents a reset signal of a reset signal terminal.

In the reset stage F1 and the data writing stage F3, the first transistor T1 is turned off under the control of a high level of the first control signal cs1; the second transistor T2 is turned on under the control of a low level of the scan signal ss1; the third transistor T3 is turned off under the control of a high level of the light emitting signal em; the fourth transistor T4 is turned off under the control of a high level of the third control signal cs3; the fifth transistor T5 is turned on under the control of a low level of the fourth control signal cs4; the sixth transistor T6 is turned off under the control of a high level of the fifth control signal cs5; the seventh transistor T7 is turned off under the control of a high level of the sixth control signal cs6; the eighth transistor T8 is turned on under the control of a low level of the reset signal re; and the ninth transistor T9 is turned on under the control of a low level of the reset signal re. The turned-on fifth transistor T5 provides a signal of the first reference voltage signal terminal VREF1 to a third node N3 in the coupling control circuit 30, then the voltage VN3 of the third node N3 is Vref1. The turned-on eighth transistor T8 provides a signal of the initialization voltage signal terminal VINIT to a gate of the driving transistor T0, then the voltage of the gate of the driving transistor T0 is Vinit. Then the bias voltage of the driving transistor T0 is Vgs=Vinit−Vdd, by presetting the value of Vinit, the bias voltage Vgs of the driving transistor T0 may be made smaller than the threshold voltage Vth of the driving transistor T0, and the driving transistor T0 is turned on. The turned-on ninth transistor T9 provides a signal of the initialization voltage signal terminal VINIT to the light emitting device L to reset the light emitting device L. The turned-on second transistor T2 provides a data voltage of the data signal terminal DA to the first node N1, then the voltage VN1 of the first node N1 is Vda. The voltage difference between the two electrodes of the third capacitor C3 is Vref1−Vda.

In the bias stage F2, the first transistor T1 is turned on under the control of a low level of the first control signal cs1; the second transistor T2 is turned off under the control of a high level of the scan signal ss1; the third transistor T3 is turned off under the control of a high level of the light emitting signal em; the fourth transistor T4 is turned off under the control of a high level of the third control signal cs3; the fifth transistor T5 is turned off under the control of a high level of the fourth control signal cs4; the sixth transistor T6 is turned off under the control of a high level of the fifth control signal cs5; the seventh transistor T7 is turned off under the control of a high level of the sixth control signal cs6; the eighth transistor T8 is turned off under the control of a high level of the reset signal re; and the ninth transistor T9 is turned off under the control of a high level of the reset signal re. The turned-on first transistor T1 provides a signal of the bias voltage signal terminal VB to the gate of the driving transistor T0, then the gate voltage of the driving transistor T0 is Vb, then the bias voltage of the driving transistor T0 is Vgs=Vb−Vdd, by presetting the value of Vb, the bias voltage Vgs of the driving transistor T0 may be made greater than the threshold voltage Vth of the driving transistor T0, and the driving transistor T0 is turned off.

In the threshold detection stage F5, the first transistor T1 is turned off under the control of a high level of the first control signal cs1; the second transistor T2 is turned off under the control of a high level of the scan signal ss1; the third transistor T3 is turned off under the control of a high level of the light emitting signal em; the fourth transistor T4 is turned on under the control of a low level of the third control signal cs3; the fifth transistor T5 is turned off under the control of a high level of the fourth control signal cs4; the sixth transistor T6 is turned on under the control of a low level of the fifth control signal cs5; the seventh transistor T7 is turned off under the control of a high level of the sixth control signal cs6; the eighth transistor T8 is turned off under the control of a high level of the reset signal re; and the ninth transistor T9 is turned off under the control of a high level of the reset signal re. The turned-on sixth transistor T6 provides a signal of the first reference voltage signal terminal VREF1 to a third node N3 of the coupling control circuit 30, then the voltage VN3 of the third node N1 is Vref1. The turned-on fourth transistor T4 controls the second electrode of the driving transistor T0 to form a conducting path with the gate of the driving transistor T0, the first power supply terminal VDD charges the gate of the driving transistor T0, the voltage of the gate of the driving transistor T0 increases constantly, when the gate voltage of the driving transistor T0 is Vdd+Vth, the bias voltage of the driving transistor T0 is Vgs=Vth, and the driving transistor T0 is turned off. The voltage difference between the two electrodes of the second capacitor C2 is Vdd+Vth−Vref1.

In the light emitting stage F4, the first transistor T1 is turned off under the control of a high level of the first control signal cs1; the second transistor T2 is turned off under the control of a high level of the scan signal ss1; the third transistor T3 is turned on under the control of a low level of the light emitting signal em; the fourth transistor T4 is turned off under the control of a high level of the third control signal cs3; the fifth transistor T5 is turned off under the control of a high level of the fourth control signal cs4; the sixth transistor T6 is turned off under the control of a high level of the fifth control signal cs5; the seventh transistor T7 is turned on under the control of a low level of the sixth control signal cs6; the eighth transistor T8 is turned off under the control of a high level of the reset signal re; and the ninth transistor T9 is turned off under the control of a high level of the reset signal re. The second capacitor C2 and the third capacitor C3 couple the data voltage Vda of the first node N1 to a gate of the driving transistor TO. The turned-on third transistor T3 makes conduction between a second electrode of the driving transistor T0 and the light emitting device L, and drives the light emitting device L to emit light. The turned-on seventh transistor T7 provides a signal of the second reference voltage signal terminal VREF2 to the first node N1, then the voltage VN1 of the first node N1 is Vref2, since the potential difference between the two ends of a series capacitor consisting of the second capacitor C2 and the third capacitor C3 remains unchanged, the gate voltage of the driving transistor T0 is Vdd+Vth+Vref2−Vda, the driving transistor T0 is turned on, and the bias voltage of the driving transistor T0 is Vgs=Vth+Vref2−Vda. The turned-on third transistor T3 makes conduction between the second electrode of the driving transistor T0 and the light emitting device L, and drives the light emitting device L to emit light. Then, the driving transistor T0 is operated in a saturation region, and a driving current I generated by the driving transistor T0 may be expressed as:

$$I = \frac{k}{2} * {( Vgs - Vth )}^{2} = \frac{k}{2} * {( Vref 2 - Vda )}^{2} .$$

Wherein, Vref2 represents a voltage value of the second reference voltage terminal VREF2.

Wherein, it should be noted that, the second capacitor C2 and the third capacitor C3 are connected in series, when the fifth transistor and the sixth transistor are in a turn-off state, the second capacitor C2 and the third capacitor C3 connected in series can function as a single capacitor in a circuit, a first electrode of the single capacitor may be coupled to the gate of the driving transistor T0, and a second electrode of the single capacitor may be coupled to the first node N1.

It should be noted that, the duration of the threshold detection stage is much longer than a row scan period of the display panel, for example, the duration of the threshold detection stage is not less than 5 row scan periods of the display panel, or not less than 40 microseconds, which can ensure suppression of the impact of the hysteresis characteristics of the threshold voltage of the driving transistor, thereby improving the display quality and effect.

In the present disclosure, during the reset stage, the driving transistor is put in a negative bias state (that is, the bias voltage Vgs of the driving transistor is less than the threshold voltage Vth, and the driving transistor is turned on); during the bias stage, the driving transistor is placed in a positive bias state (that is, the bias voltage Vgs of the driving transistor is greater than the threshold voltage Vth, and the driving transistor is turned off); that is, by combining the negative bias state and the positive bias state, the hysteresis characteristics of the driving transistor can be effectively alleviated, and the display quality can be improved.

Exemplarily, prior to the reset stage, a pre-bias stage is further included, in which the bias circuit provides a signal of the bias voltage signal terminal to a gate of the driving transistor in response to a signal of the first control signal terminal.

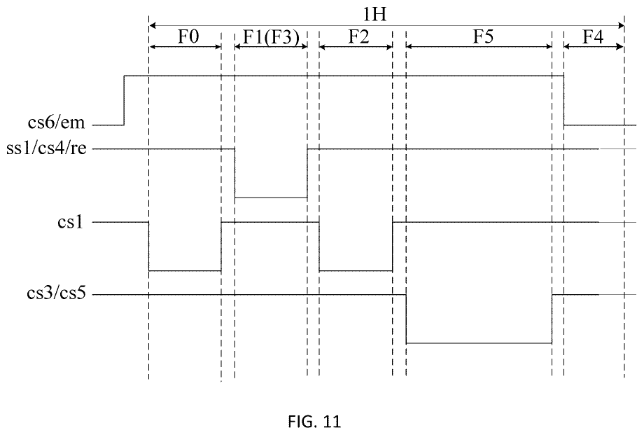

The operating process of the pixel circuit provided by the embodiment of the present disclosure will be described below with reference to the signal timing diagram shown in FIG. 11, by taking the pixel circuit shown in FIG. 9 as an example. The operating process of the pixel circuit in one display frame 1H is taken as an example for description, wherein one display frame 1H may include: a pre-bias stage F0, a reset stage F1, a bias stage F2, a data writing stage F3, a light emitting stage F4, and a threshold detection stage F5.

Wherein, as shown in FIG. 11, em represents a light emitting signal of a light emitting control signal terminal EM, cs1 represents a first control signal of a first control signal terminal CS1, cs3 represents a third control signal of a third control signal terminal CS3, cs4 represents a fourth control signal of a fourth control signal terminal CS4, cs5 represents a fifth control signal of a fifth control signal terminal CS5, cs6 represents a sixth control signal of a sixth control signal terminal CS6, ss1 represents a scan signal of a scan signal terminal SS1, and re represents a reset signal of a reset signal terminal.

In the pre-bias stage F0, the first transistor T1 is turned on under the control of a low level of the first control signal cs1; the second transistor T2 is turned off under the control of a high level of the scan signal ss1; the third transistor T3 is turned off under the control of a high level of the light emitting signal em; the fourth transistor T4 is turned off under the control of a high level of the third control signal cs3; the fifth transistor T5 is turned off under the control of a high level of the fourth control signal cs4; the sixth transistor T6 is turned off under the control of a high level of the fifth control signal cs5; the seventh transistor T7 is turned off under the control of a high level of the sixth control signal cs6; the eighth transistor T8 is turned off under the control of a high level of the reset signal re; and the ninth transistor T9 is turned off under the control of a high level of the reset signal re. The turned-on first transistor T1 provides a signal of the bias voltage signal terminal VB to the gate of the driving transistor T0, then the gate voltage of the driving transistor T0 is Vb, then the bias voltage of the driving transistor T0 is Vgs=Vb−Vdd, by presetting the value of Vb, the bias voltage Vgs of the driving transistor T0 may be made greater than the threshold voltage Vth of the driving transistor T0, and the driving transistor T0 is turned off.

Reference may be made to the above description for the operation processes in the reset stage F1, in the bias stage F2, in the data writing stage F3, in the light emitting stage F4, and in the threshold detection stage F5, which will not be repeated here.

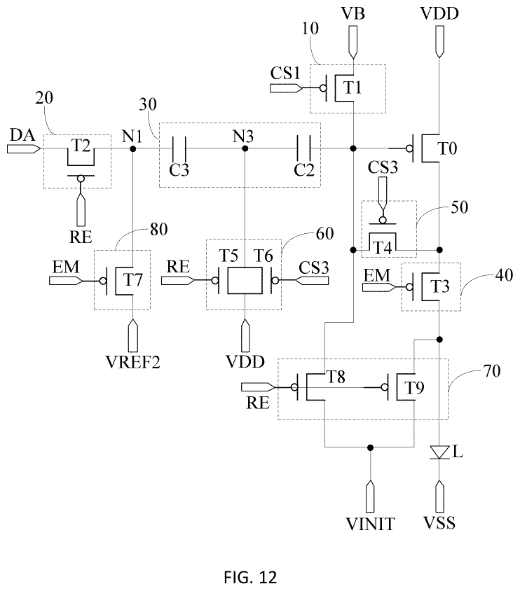

An embodiment of the present disclosure provides a schematic diagram of some other structures of the pixel circuit, which, as shown in FIG. 12, is modified based on the implementation in the above embodiments. The description below is only directed at differences between the present embodiments and the above embodiments, while the similarities between them will not be elaborated.

Exemplarily, a sixth control signal terminal CS6 may be the same signal terminal as a light emitting control signal terminal EM; a fourth control signal terminal CS4 and a scan signal terminal SS1 may be the same signal terminal as a reset signal terminal RE; a third control signal terminal CS3 may be the same signal terminal as a fifth control signal terminal CS5; and a first reference voltage signal terminal VREF1 may be the same signal terminal as a first power supply terminal VDD; whereby the number of signal lines can be reduced, and the space occupied by wiring can be saved.

Exemplarily, a gate of the second transistor T2 is coupled to the reset signal terminal RE. A gate of the fifth transistor is coupled to the reset signal terminal RE, and a first electrode of the fifth transistor T5 is coupled to the first power supply terminal VDD. A gate of the sixth transistor T6 is coupled to the third control signal terminal CS3, and a first electrode of the sixth transistor T6 is coupled to the first power supply terminal VDD. A gate of the seventh transistor T7 is coupled to the light emitting control signal terminal EM.

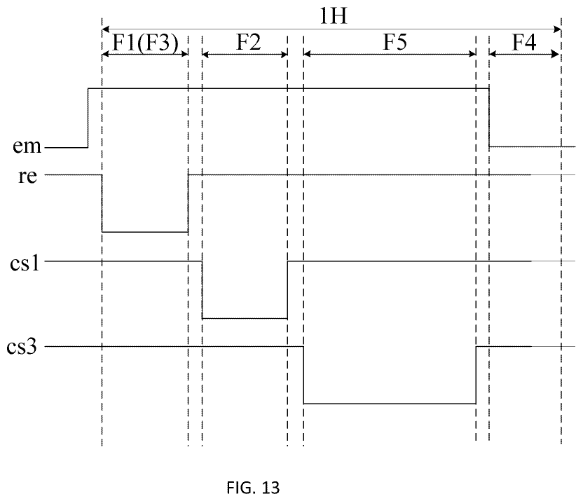

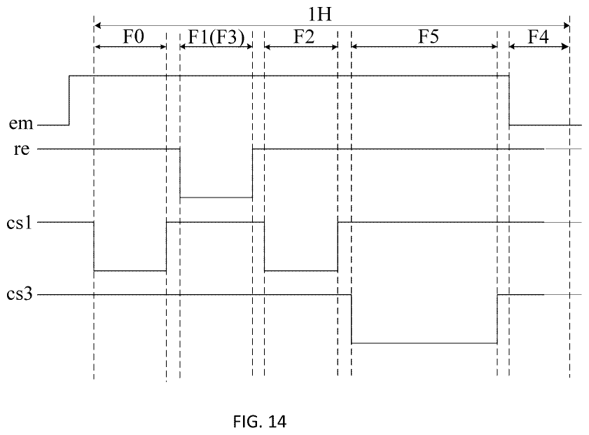

It should be noted that, the signal timing diagram corresponding to the pixel circuit as shown in FIG. 12 may be FIG. 13 or FIG. 14. Moreover, the specific operating process of the pixel circuit as shown in FIG. 12 may be basically the same as the specific operating process of the pixel circuit as shown in FIG. 9, which will not be repeated here.

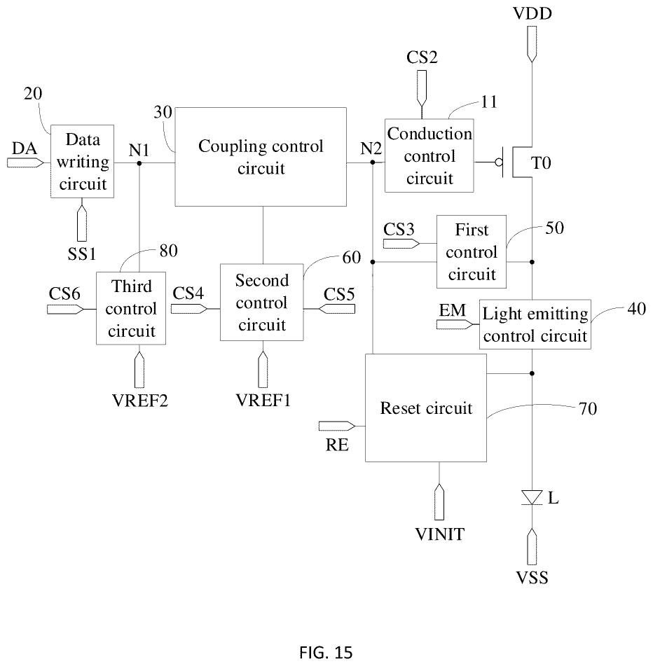

An embodiment of the present disclosure provides a pixel circuit, as shown in FIG. 15, including:
a light emitting device L;
a driving transistor T0, coupled to the light emitting device L, and configured to generate a driving current for driving the light emitting device L to emit light according to a data voltage;
a data writing circuit 20, coupled to a first node N1, and configured to provide a data voltage of a data signal terminal DA to the first node N1 in response to a signal of a scan signal terminal SS1;
a conduction control circuit 11, coupled to a gate of the driving transistor T0 and a second node N2, and configured to make conduction between the gate of the driving transistor T0 and the second node N2 in response to a signal of a second control signal terminal CS2;
a coupling control circuit 30, coupled to the first node N1 and the second node N2, and configured to couple the data voltage of the first node N1 to the second node N2; and
a light emitting control circuit 40, coupled to the light emitting device L and the driving transistor T0, configured to make conduction between a second electrode of the driving transistor T0 and the light emitting device L, and drive the light emitting device L to emit light, in response to a signal of a light emitting control signal terminal EM.

In the embodiment of the present disclosure, by means of the cooperation among the data writing circuit, the conduction control circuit, the coupling control circuit and the light emitting control circuit, the image sticking problem of the display panel can be relieved, and meanwhile, the brightness stability of the display panel can be increased, the flicker problem of the display panel can be relieved, and the display quality can be improved. It is further favorable for improving a compensation effect of the spatial variability of the threshold voltage Vth, and is also favorable for achieving an energy-saving effect in a low frame rate display state.

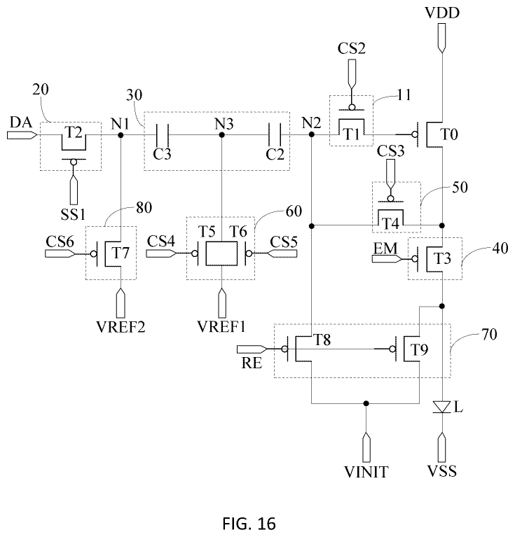

In some embodiments of the present disclosure, as shown in FIG. 16, the conduction control circuit 11 includes: a first transistor T1; wherein a gate of the first transistor T1 is coupled to the second control signal terminal CS2, a first electrode of the first transistor T1 is coupled to the second node N2, and a second electrode of the first transistor T1 is coupled to a gate of the driving transistor T0.

In some embodiments of the present disclosure, as shown in FIG. 16, the data writing circuit 20 includes: a second transistor T2; wherein a gate of the second transistor T2 is coupled to the scan signal terminal SS1, a first electrode of the second transistor T2 is coupled to the data signal terminal DA, and a second electrode of the second transistor T2 is coupled to the first node N1.

In some embodiments of the present disclosure, as shown in FIG. 16, the coupling control circuit 30 includes: a second capacitor C2 and a third capacitor C3; wherein a first electrode of the second capacitor C2 is coupled to the second node N2, a second electrode of the second capacitor C2 is coupled to a first electrode of the third capacitor C3; and a second electrode of the third capacitor C3 is coupled to the first node N1.

In some embodiments of the present disclosure, as shown in FIG. 16, the light emitting control circuit 40 includes: a third transistor T3; wherein a gate of the third transistor T3 is coupled to a light emitting control signal terminal EM, a first electrode of the third transistor T3 is coupled to the second electrode of the driving transistor T0, and a second electrode of the third transistor T3 is coupled to the light emitting device L.

In some embodiments of the present disclosure, as shown in FIG. 16, further included is a first control circuit 50, coupled to the gate of the driving transistor T0 and the second electrode of the driving transistor T0, configured to control the second electrode of the driving transistor T0 to form a conducting path with the second node N2 in response to a signal of a third control signal terminal CS3.

In some embodiments of the present disclosure, as shown in FIG. 16, the first control circuit includes: a fourth transistor T4; wherein a gate of the fourth transistor T4 is coupled to the third control signal terminal CS3, a first electrode of the fourth transistor T4 is coupled to the second electrode of the driving transistor T0, and the second electrode of the fourth transistor T4 is coupled to the second node N2.

In some embodiments of the present disclosure, as shown in FIG. 16, further included is a second control circuit 60, coupled to the coupling control circuit 30, configured to provide a signal of a first reference voltage signal terminal VREF1 to the coupling control circuit 30 in response to a signal of a fourth control signal terminal CS4 or a fifth control signal terminal CS5.

In some embodiments of the present disclosure, as shown in FIG. 16, the second control circuit 60 includes: a fifth transistor T5 and a sixth transistor T6; wherein a gate of the fifth transistor T5 is coupled to the fourth control signal terminal CS4, a first electrode of the fifth transistor T5 is coupled to the first reference voltage signal terminal VREF1, a second electrode of the fifth transistor T5 is coupled to the coupling control circuit 30; a gate of the sixth transistor T6 is coupled to a signal of the fifth control signal terminal CS5, a first electrode of the sixth transistor T6 is coupled to the first reference voltage signal terminal VREF1, and a second electrode of the sixth transistor T6 is coupled to the coupling control circuit 30.

In some embodiments of the present disclosure, as shown in FIG. 16, further included is a reset circuit 70, coupled to a gate of the driving transistor T0 and coupled to a light emitting device L, configured to provide a signal of an initialization voltage signal terminal VINIT to the second node N2 and the light emitting device L, respectively, in response to a signal of a reset signal terminal RE.

In some embodiments of the present disclosure, as shown in FIG. 16, the reset circuit 70 includes: an eighth transistor T8 and a ninth transistor T9; wherein a gate of the eighth transistor T8 is coupled to the reset signal terminal RE, a first electrode of the eighth transistor T8 is coupled to the second node N2, and a second electrode of the eighth transistor T8 is coupled to an initialization voltage signal terminal VINIT; a gate of the ninth transistor T9 is coupled to the reset signal terminal RE, a first electrode of the ninth transistor T9 is coupled to a light emitting device L, and a second electrode of the ninth transistor T9 is coupled to the initialization voltage signal terminal VINIT.

In some embodiments of the present disclosure, as shown in FIG. 16, further included is a third control circuit 80, coupled to the first node N1, configured to provide a signal of a second reference voltage signal terminal VREF2 to the first node N1 in response to a signal of a sixth control signal terminal CS6.

In some embodiments of the present disclosure, as shown in FIG. 16, the third control circuit 80 includes: a seventh transistor T7; wherein a gate of the seventh transistor T7 is coupled to the signal of the sixth control signal terminal CS6, a first electrode of the seventh transistor T7 is coupled to the second reference voltage signal terminal VREF2, and a second electrode of the seventh transistor T7 is coupled to the first node N1.

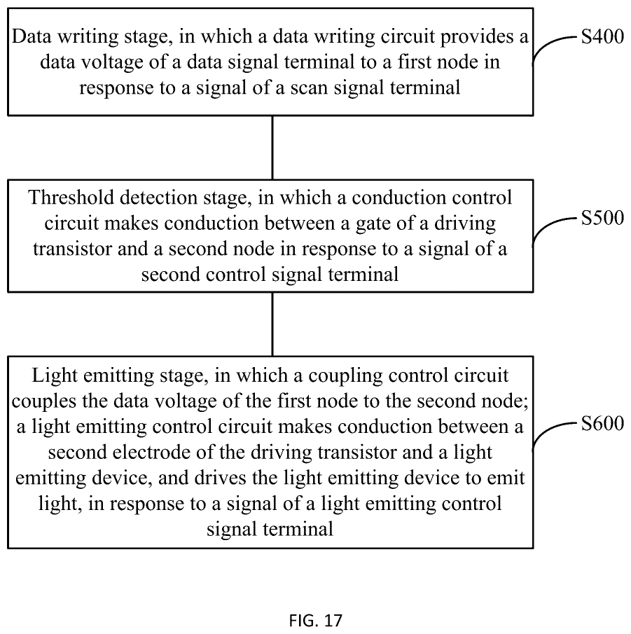

An embodiment of the present disclosure provides a driving method of a pixel circuit, as shown in FIG. 17, including:
S400, a data writing stage, in which a data writing circuit provides a data voltage of a data signal terminal to a first node in response to a signal of a scan signal terminal;
S500, a threshold detection stage, in which a conduction control circuit makes conduction between a gate of a driving transistor and a second node in response to a signal of a second control signal terminal;
S600, a light emitting stage, in which a coupling control circuit couples the data voltage of the first node to the second node; a light emitting control circuit makes conduction between a second electrode of the driving transistor and a light emitting device, and drives the light emitting device to emit light, in response to a signal of a light emitting control signal terminal.

It should be noted that, in the data writing stage: a reset stage may further be included, in which a reset circuit provides a signal of an initialization voltage signal terminal to the second node and the light emitting device, respectively, in response to a signal of a reset signal terminal. After the light emitting stage, a signal superposition stage may further be included, in which a coupling control circuit couples a data voltage of the first node to the second node.

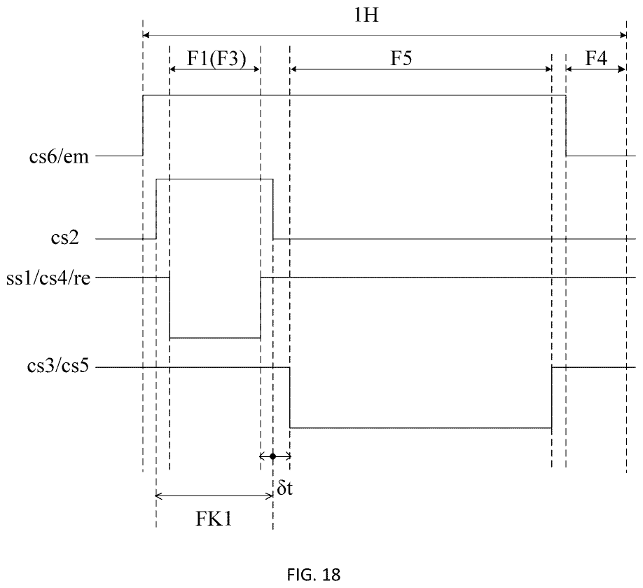

The operating process of the pixel circuit provided by the embodiment of the present disclosure will be described below with reference to the signal timing diagram shown in FIG. 18, by taking the pixel circuit shown in FIG. 16 as an example. The operating process of the pixel circuit in one display frame 1H is taken as an example for description, wherein one display frame 1H may include: a reset stage F1, a data writing stage F3, a light emitting stage F4, and a threshold detection stage F5.

Wherein, as shown in FIG. 18, em represents a light emitting signal of a light emitting control signal terminal EM, cs2 represents a second control signal of a second control signal terminal CS2, cs3 represents a third control signal of a third control signal terminal CS3, cs4 represents a fourth control signal of a fourth control signal terminal CS4, cs5 represents a fifth control signal of a fifth control signal terminal CS5, cs6 represents a sixth control signal of a sixth control signal terminal CS6, ss1 represents a scan signal of a scan signal terminal SS1, and re represents a reset signal of a reset signal terminal.

In the reset stage F1 and the data writing stage F3, the first transistor T1 is turned off under the control of a high level of the second control signal cs2; the second transistor T2 is turned on under the control of a low level of the scan signal ss1; the third transistor T3 is turned off under the control of a high level of the light emitting signal em; the fourth transistor T4 is turned off under the control of a high level of the third control signal cs3; the fifth transistor T5 is turned on under the control of a low level of the fourth control signal cs4; the sixth transistor T6 is turned off under the control of a high level of the fifth control signal cs5; the seventh transistor T7 is turned off under the control of a high level of the sixth control signal cs6; the eighth transistor T8 is turned on under the control of a low level of the reset signal re; and the ninth transistor T9 is turned on under the control of a low level of the reset signal re. The turned-on fifth transistor T5 provides a signal of the first reference voltage signal terminal VREF1 to a third node N3 in the coupling control circuit 30, then the voltage VN3 of the third node N3 is Vref1. The turned-on eighth transistor T8 provides a signal of the initialization voltage signal terminal VINIT to a second node N2, then the voltage VN2 of the second node N2 is Vinit. The turned-on ninth transistor T9 provides a signal of the initialization voltage signal terminal VINIT to the light emitting device L to reset the light emitting device L. The turned-on second transistor T2 provides a data voltage of the data signal terminal DA to the first node N1, then the voltage VN1 of the first node N1 is Vda. The voltage difference between the two electrodes of the third capacitor C3 is Vref1−Vda. It should be noted that, during the reset stage F1, the driving transistor TO is in a floating FK1 state.

In the threshold detection stage F5, the first transistor T1 is turned on under the control of a low level of the second control signal cs2; the second transistor T2 is turned off under the control of a high level of the scan signal ss1; the third transistor T3 is turned off under the control of a high level of the light emitting signal em; the fourth transistor T4 is turned on under the control of a low level of the third control signal cs3; the fifth transistor T5 is turned off under the control of a high level of the fourth control signal cs4; the sixth transistor T6 is turned on under the control of a low level of the fifth control signal cs5; the seventh transistor T7 is turned off under the control of a high level of the sixth control signal cs6; the eighth transistor T8 is turned off under the control of a high level of the reset signal re; and the ninth transistor T9 is turned off under the control of a high level of the reset signal re. The turned-on sixth transistor T6 provides a signal of the first reference voltage signal terminal VREF1 to a third node N3 of the coupling control circuit 30, then the voltage VN3 of the third node is Vref1. The turned-on fourth transistor T4 controls the second electrode of the driving transistor T0 to form a conducting path with the second node N2, the turned-on first transistor T1 makes conduction between the second node N2 and the gate of the driving transistor T0, the first power supply terminal VDD charges the gate of the driving transistor T0, the voltage of the gate of the driving transistor T0 increases constantly, when the gate voltage of the driving transistor T0 is Vdd+Vth, the bias voltage of the driving transistor T0 is Vgs=Vth, and the driving transistor T0 is turned off. The voltage difference between the two electrodes of the second capacitor C2 is Vdd+Vth−Vref1.

In the light emitting stage F4, the first transistor T1 is turned on under the control of a low level of the second control signal cs2; the second transistor T2 is turned off under the control of a high level of the scan signal ss1; the third transistor T3 is turned on under the control of a low level of the light emitting signal em; the fourth transistor T4 is turned off under the control of a high level of the third control signal cs3; the fifth transistor T5 is turned off under the control of a high level of the fourth control signal cs4; the sixth transistor T6 is turned off under the control of a high level of the fifth control signal cs5; the seventh transistor T7 is turned on under the control of a low level of the sixth control signal cs6; the eighth transistor T8 is turned off under the control of a high level of the reset signal re; and the ninth transistor T9 is turned off under the control of a high level of the reset signal re. The second capacitor C2 and the third capacitor C3 couple the data voltage of the first node N1 to the second node N2. The turned-on first transistor T1 makes conduction between the second node N2 and the gate of the driving transistor T0. The turned-on third transistor T3 makes conduction between a second electrode of the driving transistor T0 and the light emitting device L, and drives the light emitting device L to emit light. The turned-on seventh transistor T7 provides a signal of the second reference voltage signal terminal VREF2 to the first node N1, then the voltage VN1 of the first node N1 is Vref2, since the potential difference between the two ends of a series capacitor consisting of the second capacitor C2 and the third capacitor C3 remains unchanged, the gate voltage of the driving transistor T0 is Vdd+Vth+Vref2−Vda, the driving transistor T0 is turned on, and the bias voltage of the driving transistor T0 is Vgs=Vth+Vref2−Vda. The turned-on third transistor T3 makes conduction between a second electrode of the driving transistor T0 and the light emitting device L, and drives the light emitting device L to emit light. Then, the driving transistor T0 is operated in a saturation region, and a driving current I generated by the driving transistor T0 may be expressed as:

$$I = \frac{k}{2} * {( Vgs - Vth )}^{2} = \frac{k}{2} * {( Vref 2 - Vda )}^{2} .$$

Wherein, Vref2 represents a voltage value of the second reference voltage terminal VREF2.

Wherein, it should be noted that, the second capacitor C2 and the third capacitor C3 are connected in series, when the fifth transistor and the sixth transistor are in a turn-off state, the second capacitor C2 and the third capacitor C3 connected in series can function as a single capacitor in a circuit, a first electrode of the single capacitor may be coupled to the second node N2, and a second electrode of the single capacitor may be coupled to the first node N1.

It should be noted that, the duration of an interval time St between the end of the floating FK1 state and the start of the threshold detection stage F5 should be much shorter than the duration of the reset stage F1, which can improve the hysteresis effect of the threshold voltage of the driving transistor.

In the present disclosure, during the reset stage, the driving transistor is put in a floating state, so that the operating process in the reset stage will not affect the driving transistor, and thus will not have a significant impact on the brightness stability of the display panel. However, the driving transistor is not reset, and the image sticking problem of the display panel cannot suppressed effectively, thus the duration of the threshold detection stage should be much longer than a row scan period of the display panel, for example, the duration of the threshold detection stage is not less than 5 row scan periods of the display panel, or not less than 40 microseconds, which can ensure suppression of the impact of the hysteresis characteristics of the threshold voltage of the driving transistor, thereby improving the display quality and effect.

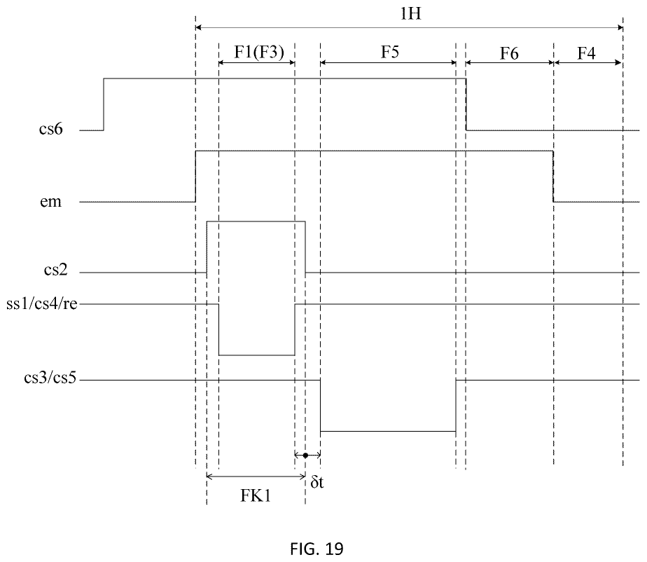

The operating process of the pixel circuit provided by the embodiment of the present disclosure will be described below with reference to the signal timing diagram shown in FIG. 18, by taking the pixel circuit shown in FIG. 16 as an example. The operating process of the pixel circuit in one display frame 1H is taken as an example for description, wherein one display frame 1H may include: a reset stage F1, a data writing stage F3, a light emitting stage F4, a threshold detection stage F5, and a signal superposition stage F6.

Wherein, as shown in FIG. 19, em represents a light emitting signal of a light emitting control signal terminal EM, cs2 represents a second control signal of a second control signal terminal CS2, cs3 represents a third control signal of a third control signal terminal CS3, cs4 represents a fourth control signal of a fourth control signal terminal CS4, cs5 represents a fifth control signal of a fifth control signal terminal CS5, cs6 represents a sixth control signal of a sixth control signal terminal CS6, ss1 represents a scan signal of a scan signal terminal SS1, and re represents a reset signal of a reset signal terminal.

In the signal superposition stage F6 and the light emitting stage F4, the first transistor T1 is turned on under the control of a low level of the second control signal cs2; the second transistor T2 is turned off under the control of a high level of the scan signal ss1; the third transistor T3 is turned off under the control of a high level of the light emitting signal em; the fourth transistor T4 is turned off under the control of a high level of the third control signal cs3; the fifth transistor T5 is turned off under the control of a high level of the fourth control signal cs4; the sixth transistor T6 is turned off under the control of a high level of the fifth control signal cs5; the seventh transistor T7 is turned on under the control of a low level of the sixth control signal cs6; the eighth transistor T8 is turned off under the control of a high level of the reset signal re; and the ninth transistor T9 is turned off under the control of a high level of the reset signal re. The second capacitor C2 and the third capacitor C3 couple the data voltage Vda of the first node N1 to the second node. The turned-on seventh transistor T7 provides a signal of the second reference voltage signal terminal VREF2 to the first node N1. The turned-on first transistor T1 makes conduction between the second node N2 and the gate of the driving transistor T0.

Reference may be made to the above description for the operation processes in the reset stage F1, in the data writing stage F3, in the light emitting stage F4, and in the threshold detection stage F5, which will not be repeated here.

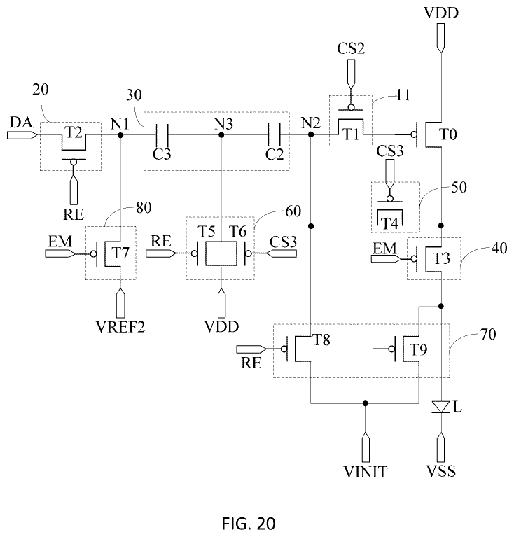

An embodiment of the present disclosure provides a schematic diagram of some other structures of the pixel circuit, which, as shown in FIG. 20, is modified based on the implementation in the above embodiments. The description below is only directed at differences between the present embodiments and the above embodiments, while the similarities between them will not be elaborated.

Exemplarily, a sixth control signal terminal CS6 may be the same signal terminal as a light emitting control signal terminal EM; a fourth control signal terminal CS4 and a scan signal terminal SS1 may be the same signal terminal as a reset signal terminal RE; a third control signal terminal CS3 may be the same signal terminal as a fifth control signal terminal CS5; and a first reference voltage signal terminal VREF1 may be the same signal terminal as a first power supply terminal VDD; whereby the number of signal lines can be reduced, and the space occupied by wiring can be saved.

Exemplarily, a gate of the second transistor T2 is coupled to the reset signal terminal RE. A gate of the fifth transistor is coupled to the reset signal terminal RE, and a first electrode of the fifth transistor T5 is coupled to the first power supply terminal VDD. A gate of the sixth transistor T6 is coupled to the third control signal terminal CS3, and a first electrode of the sixth transistor T6 is coupled to the first power supply terminal VDD. A gate of the seventh transistor T7 is coupled to the light emitting control signal terminal EM.

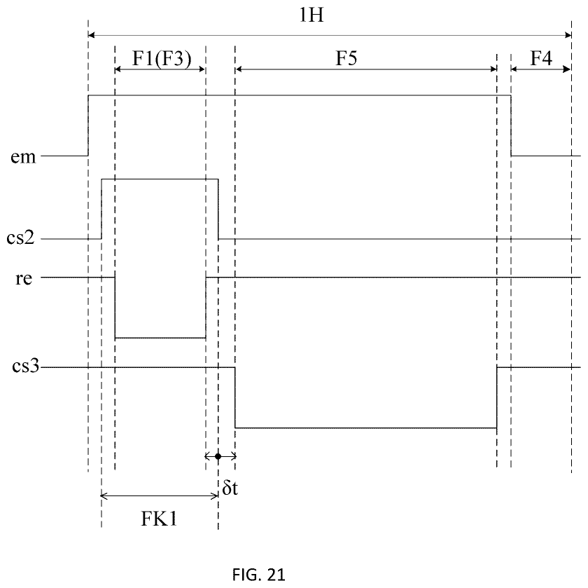

It should be noted that, the signal timing diagram corresponding to the pixel circuit as shown in FIG. 20 may be FIG. 21. Moreover, the specific operating process of the pixel circuit as shown in FIG. 20 may be basically the same as the specific operating process of the pixel circuit as shown in FIG. 16, which will not be repeated here.

Based on the same disclosure concept, an embodiment of the present disclosure also provides a display apparatus, including the above pixel circuit provided by the embodiments of the present disclosure. Since the principle of the display apparatus for solving the problem is similar to the principle of the above pixel circuit for solving the problem, for the implementation of the display apparatus, reference may be made to the implementation of the above pixel circuit, which will not be repeated herein.

Exemplarily, the display apparatus provided by the embodiment of the present disclosure may include a display panel. The display panel may include a base substrate. Wherein, the base substrate may include a display area and a non-display area (i.e. an area in the base substrate except the area surrounded by the display area). Wherein, the display area may include a plurality of pixel units arranged in an array. Exemplarily, each pixel unit includes sub-pixels of the same color or sub-pixels of multiple different colors. For example, the pixel unit may include a red sub-pixel, a green sub-pixel and a blue sub-pixel, so that red, green and blue colors can be mixed to achieve color display. Alternatively, the pixel unit may also include a red sub-pixel, a green sub-pixel, a blue sub-pixel and a white sub-pixel, so that red, green, blue and white colors can be mixed to achieve color display. Of course, in practical applications, the colors of light emitted by the sub-pixels in a pixel unit can be designed and determined according to the actual application environment, which are not limited here.

In a specific implementation, according to the embodiment of the present disclosure, the display apparatus may be: a mobile phone, a tablet computer, a television, a display, a notebook computer, a digital photo frame, a navigator, or any other products or components that have display function. Those of ordinary skill in the art should understand that other essential components of the display apparatus are also provided, which will not be repeated here, and which should not be used to limit the present disclosure.

While preferred embodiments of the present disclosure have been described, additional changes and modifications to these embodiments can be made by those skilled in the art once the basic inventive concept is appreciated. Therefore, it is intended that the appended claims be construed to cover the preferred embodiments as well as all changes and modifications which fall within the scope of the present disclosure.

Apparently, those skilled in the art can make various modifications and variations to the embodiments of the present disclosure without departing from the spirit and scope of the embodiments of the present disclosure. In this way, if the modifications and variations of the embodiments of the present disclosure fall within the scope of the claims of the present disclosure and equivalent technologies, the present disclosure also intends to include these modifications and variations.

1-19. (canceled)

20. A pixel circuit, comprising:
a light emitting device;
a driving transistor, coupled to the light emitting device, and configured to generate a driving current for driving the light emitting device to emit light according to a data voltage;
a bias circuit, coupled to a gate of the driving transistor, and configured to provide a signal of a bias voltage signal terminal to the gate of the driving transistor in response to a signal of a first control signal terminal;
a data writing circuit, coupled to a first node, and configured to provide the data voltage of a data signal terminal to the first node in response to a signal of a scan signal terminal;
a coupling control circuit, coupled to the gate of the driving transistor and the first node, and configured to couple the data voltage of the first node to the gate of the driving transistor; and
a light emitting control circuit, coupled to the light emitting device and the driving transistor, configured to make conduction between a second electrode of the driving transistor and the light emitting device, and drive the light emitting device to emit light, in response to a signal of a light emitting control signal terminal.

21. The pixel circuit according to claim 20, wherein the bias circuit comprises: a first transistor;
a gate of the first transistor is coupled to the first control signal terminal, a first electrode of the first transistor is coupled to the gate of the driving transistor, and a second electrode of the first transistor is coupled to the bias voltage signal terminal.

22. A pixel circuit, comprising:
a light emitting device;
a driving transistor, coupled to the light emitting device, and configured to generate a driving current for driving the light emitting device to emit light according to a data voltage;
a data writing circuit, coupled to a first node, and configured to provide the data voltage of a data signal terminal to the first node in response to a signal of a scan signal terminal;
a conduction control circuit, coupled to a gate of the driving transistor and a second node, and configured to make conduction between the gate of the driving transistor and the second node in response to a signal of a second control signal terminal;
a coupling control circuit, coupled to the first node and the second node, and configured to couple the data voltage of the first node to the second node; and
a light emitting control circuit, coupled to the light emitting device and the driving transistor, configured to make conduction between a second electrode of the driving transistor and the light emitting device, and drive the light emitting device to emit light, in response to a signal of a light emitting control signal terminal.

23. The pixel circuit according to claim 22, wherein the conduction control circuit comprises: a first transistor; and
a gate of the first transistor is coupled to the second control signal terminal, a first electrode of the first transistor is coupled to the second node, and a second electrode of the first transistor is coupled to the gate of the driving transistor.

24. The pixel circuit according to claim 20, wherein the data writing circuit comprises: a second transistor; and
a gate of the second transistor is coupled to the scan signal terminal, a first electrode of the second transistor is coupled to the data signal terminal, and a second electrode of the second transistor is coupled to the first node.

25. The pixel circuit according to claim 20, wherein the coupling control circuit comprises: a first capacitor; and
a first electrode of the first capacitor is coupled to the gate of the driving transistor or a second node, and a second electrode of the first capacitor is coupled to the first node.

26. The pixel circuit according to claim 20, wherein the coupling control circuit comprises: a second capacitor and a third capacitor;
a first electrode of the second capacitor is coupled to the gate of the driving transistor or a second node, and a second electrode of the second capacitor is coupled to a first electrode of the third capacitor; and
a second electrode of the third capacitor is coupled to the first node.

27. The pixel circuit according to claim 20, wherein the light emitting control circuit comprises: a third transistor; and
a gate of the third transistor is coupled to the light emitting control signal terminal, a first electrode of the third transistor is coupled to the second electrode of the driving transistor, and a second electrode of the third transistor is coupled to the light emitting device.

28. The pixel circuit according to claim 20, further comprising: a first control circuit, coupled to the gate of the driving transistor or a second node, and coupled to the second electrode of the driving transistor, and configured to control the second electrode of the driving transistor to form a conducting path with the gate of the driving transistor or the second node in response to a signal of a third control signal terminal.

29. The pixel circuit according to claim 28, wherein the first control circuit comprises: a fourth transistor;
a gate of the fourth transistor is coupled to the third control signal terminal, a first electrode of the fourth transistor is coupled to the second electrode of the driving transistor, and a second electrode of the fourth transistor is coupled to the gate of the driving transistor or the second node.

30. The pixel circuit according to claim 20, further comprising: a second control circuit, coupled to the coupling control circuit, and configured to provide a signal of a first reference voltage signal terminal to the coupling control circuit in response to a signal of a fourth control signal terminal or a fifth control signal terminal.

31. The pixel circuit according to claim 30, wherein the second control circuit comprises: a fifth transistor and a sixth transistor;
a gate of the fifth transistor is coupled to the fourth control signal terminal, a first electrode of the fifth transistor is coupled to the first reference voltage signal terminal, and a second electrode of the fifth transistor is coupled to the coupling control circuit; and
a gate of the sixth transistor is coupled to the fifth control signal terminal, a first electrode of the sixth transistor is coupled to the first reference voltage signal terminal, and a second electrode of the sixth transistor is coupled to the coupling control circuit.

32. The pixel circuit according to claim 20, further comprising: a third control circuit, coupled to the first node, and configured to provide a signal of a second reference voltage signal terminal to the first node in response to a signal of a sixth control signal terminal.

33. The pixel circuit according to claim 32, wherein the third control circuit comprises: a seventh transistor; and
a gate of the seventh transistor is coupled to the signal of the sixth control signal terminal, a first electrode of the seventh transistor is coupled to the second reference voltage signal terminal, and a second electrode of the seventh transistor is coupled to the first node.

34. The pixel circuit according to claim 20, further comprising: a reset circuit, coupled to a gate of the driving transistor or a second node, and coupled to the light emitting device, configured to provide a signal of an initialization voltage signal terminal to the gate of the driving transistor or the second node, and the light emitting device respectively, in response to a signal of a reset signal terminal.

35. The pixel circuit according to claim 34, wherein the reset circuit comprises: an eighth transistor and a ninth transistor; and
a gate of the eighth transistor is coupled to the reset signal terminal, a first electrode of the eighth transistor is coupled to the gate of the driving transistor or the second node, and a second electrode of the eighth transistor is coupled to the initialization voltage signal terminal; and
a gate of the ninth transistor is coupled to the reset signal terminal, a first electrode of the ninth transistor is coupled to the light emitting device, and a second electrode of the ninth transistor is coupled to the initialization voltage signal terminal.

36. A display apparatus, comprising a pixel circuit, wherein the pixel circuit comprises:
a light emitting device;
a driving transistor, coupled to the light emitting device, and configured to generate a driving current for driving the light emitting device to emit light according to a data voltage;
a bias circuit, coupled to a gate of the driving transistor, and configured to provide a signal of a bias voltage signal terminal to the gate of the driving transistor in response to a signal of a first control signal terminal;
a data writing circuit, coupled to a first node, and configured to provide the data voltage of a data signal terminal to the first node in response to a signal of a scan signal terminal;
a coupling control circuit, coupled to the gate of the driving transistor and the first node, and configured to couple the data voltage of the first node to the gate of the driving transistor; and
a light emitting control circuit, coupled to the light emitting device and the driving transistor, configured to make conduction between a second electrode of the driving transistor and the light emitting device, and drive the light emitting device to emit light, in response to a signal of a light emitting control signal terminal.

37. A driving method of the pixel circuit according to claim 20, comprising:
in a bias stage, providing, by the bias circuit, the signal of the bias voltage signal terminal to the gate of the driving transistor in response to the signal of the first control signal terminal;
in a data writing stage, providing, by the data writing circuit, the data voltage of the data signal terminal to the first node in response to the signal of the scan signal terminal; and
in a light emitting stage, coupling, by the coupling control circuit, the data voltage of the first node to the gate of the driving transistor; and making conduction, by the light emitting control circuit, between the second electrode of the driving transistor and the light emitting device, and driving the light emitting device to emit light, in response to the signal of the light emitting control signal terminal.

38. A driving method of the pixel circuit according to claim 22, comprising:
in a data writing stage, providing, by the data writing circuit, the data voltage of the data signal terminal to the first node in response to the signal of the scan signal terminal;
in a threshold detection stage, making conduction, by the conduction control circuit, between the gate of the driving transistor and the second node in response to the signal of the second control signal terminal; and
in a light emitting stage, coupling, by the coupling control circuit, the data voltage of the first node to the second node; making conduction, by the light emitting control circuit, between the second electrode of the driving transistor and the light emitting device, and driving the light emitting device to emit light, in response to the signal of the light emitting control signal terminal.

39. A display apparatus, comprising the pixel circuit according to claim 22.
